(19) United States
(12) Patent Application Publication
(10) Pub. No.: US 2022/0196803 A1
(43) Pub. Date: Jun. 23, 2022

(54) LIDAR SENSOR

(71) Applicant: Robert Bosch GmbH, Stuttgart (DE)

(72) Inventors: Hans-Jochen Schwarz, Karlsruhe (DE); Norman Haag, Stuttgart (DE)

(21) Appl. No.: 17/644,874

(22) Filed: Dec. 17, 2021

(30) Foreign Application Priority Data
Dec. 23, 2020 (DE) 10 2020 216 528.9

(51) Int. Cl. G01S 7/481; G01S 7/484; G01S 17/931; G02B 5/02

(52) U.S. Cl. CPC G01S 7/4814; G02B 5/0252; G01S 17/931; G01S 7/484

(57) ABSTRACT

A LIDAR sensor, which includes a transmitting unit and a deflection unit. The transmitting unit is configured to generate a laser beam, whose local beam distribution includes a double peak distribution along a deflection direction of the deflection unit. The light energy of which in a central section between the two peaks is less by a predefined factor than the light energy in sections in each case laterally adjacent thereto, which include the peaks. The deflection unit is configured to deflect the laser beam generated by the transmitting unit along the deflection direction into surroundings of the LIDAR sensor.

### CROSS REFERENCE

The present application claims the benefit under 35 U.S.C. § 119 of German Patent Application No. DE 102020216528.9 filed on Dec. 23, 2020, which is expressly incorporated herein by reference in its entirety.

### FIELD

The present invention relates to a LIDAR sensor and, in particular, to a LIDAR sensor for a means of transportation (i.e., transportation device).

### BACKGROUND INFORMATION

LIDAR sensors of different types, which are used, for example, for detecting the surroundings of a vehicle, are known from the related art. Such LIDAR sensors represent highly sensitive distance measuring devices, which ascertain via direct or indirect methods the propagation time between a distant object and the LIDAR sensor on the basis of an emitted laser beam. Such sensors typically target a very long distance in the range of 100 m to 300 m or more, which correspondingly entail very high demands on respective transceiver technologies of these LIDAR sensors. A maximum achievable distance in this case is determined not only by the underlying technology of the LIDAR sensor, but is also strongly a function of requirements of an eye-safe design of LIDAR sensors.

When using light in the near infrared wavelength range (<1400 nm), in particular, the emitted laser beam of the LIDAR sensor is not absorbed at the surface of the eye but is mapped on the retina. As a result, a targeted design of the LIDAR sensors is particularly important with respect to eye safety in this wavelength range.

In terms of eye safety, aspects such as a pulse duration of the laser beam, a scanning method used, a structure of the laser beam at a great distance from the sensor and a structure of the laser beam directly at the exit from a protective glass of the LIDAR sensor, among others, are decisive and are accordingly considered in a design of the LIDAR sensors.

German Patent Application No. DE 102017213726 A1 describes a sensor device for detecting an object with the aid of light of at least one wavelength, a light emitted from a transmitting unit of the sensor device having the shape of an area in a plane perpendicular to a transmission path, which includes an inner area not impacted by light.

German Patent Application No. DE102018212735 A1 describes a LIDAR device for scanning a scanning area, a transmitting unit of the LIDAR device including at least one diffusion disk element in an optical path of emitted electromagnetic beams. The diffusion disk element diffuses the emitted power of the beam source into a desired spatial angle or scanning area and thereby enhances the eye safety of the LIDAR device.

### SUMMARY

According to an example embodiment of the present invention, a LIDAR sensor is provided, which includes a transmitting unit and a deflection unit. The LIDAR sensor is preferably a LIDAR sensor of a surroundings detection system of a means of transportation, the means of transportation being, for example, a road vehicle (for example, a motorcycle, passenger car, a transporter, a truck) or a railway vehicle or an aircraft/airplane and/or a watercraft, without thereby limiting the LIDAR sensor to an exclusive use in conjunction with a surroundings detection system and/or a means of transportation.

The transmitting unit is configured, for example, with the aid of a semiconductor laser (laser diode), or with the aid of a laser technology differing therefrom, to generate a laser beam whose local beam distribution includes a double-peak distribution along a deflection direction (scanning direction) of the deflection unit, the light energy of which in a central section between the two peaks (i.e., between the two peak values of the distribution) is less by a predefined factor than the light energy in sections in each case laterally adjacent thereto, which include the peaks. It is noted that it is possible, depending on the design of the LIDAR sensor, for the transmitting unit to include a plurality of semiconductor lasers so that, for example, a scanning line is generated by semiconductor lasers situated one above the other.

The deflection unit includes, for example, one or multiple rotating mirrors, the deflection direction being predefined in this case by a direction of rotation of the deflection unit. Alternatively or in addition to such a rotating deflection unit, it is conceivable that the deflection unit is implemented on the basis of a plurality of micromirrors or of a technology differing therefrom. The deflection unit is configured to deflect the laser beam generated by the transmitting unit along the deflection direction into surroundings of the LIDAR sensor. The deflection direction is understood to mean the direction that corresponds to a main scanning direction of the LIDAR sensor. In conjunction with a use of the LIDAR sensor in a surroundings detection system of a vehicle, the main scanning direction corresponds, for example, to a horizontal direction, as a result of which surroundings of the vehicle are scanned, for example, from left to right or vice versa. This does not explicitly preclude the main scanning direction from also corresponding to a vertical or to a diagonal direction. Nor does this preclude the laser beam from experiencing, in addition to the main scanning direction, a further deflection (for example, orthogonally to the main scanning direction) during the scanning of the surroundings.

The above-described double peak distribution of the laser beam of the LIDAR sensor according to the present invention yields the advantage that this LIDAR sensor is able to ensure eye safety at, in principle, arbitrary distances to the LIDAR sensor. In the case of an essentially frontal view of the laser beam exiting from the LIDAR sensor, the individual peaks of the double peak distribution reach the retina of an observer one after the other due to their local distribution and to the scanning movement of the LIDAR sensor, so that a total energy of the laser light incident in the eye is distributed over time, thereby enhancing eye safety accordingly. A pattern of the laser beam incident in the eye of the observer represents in this case a convolution of the beam distribution with the pupil function of the eye, which results essentially in a widening of the distribution.

Preferred refinements of the present invention are disclosed herein.

A height and/or a width of the peak and/or a spacing of the peaks of the double peak distribution are particularly advantageously established in accordance with predefined eye safety requirements of the LIDAR sensor. When establishing this, further parameters relating to eye safety, such as a pulse duration of the laser beam, a divergence of the laser beam, a scattering effect of optical elements within the optical path of the LIDAR sensor, a maximum transmitting power, a scanning direction, a scanning velocity of the LIDAR sensor, etc. are preferably taken into consideration.

In accordance with an example embodiment of the present invention, the LIDAR sensor is preferably configured to ensure the eye safety in a close range of a light exit interface of the LIDAR sensor, the close range corresponding to a distance of up to 10 m, preferably up to 5 m and, in particular, preferably up to 1 m from the light exit interface of the LIDAR sensor. The light exit interface is, for example, a window optically transparent for the laser beam, which may be a planar or a curved window. It is noted that the LIDAR sensor according to the present invention is also able to ensure eye safety at distances to the light exit interface differing therefrom. In principle, it is possible to design the provided double peak distribution in such a way that this distribution is reflected also at a distant range (for example, at a distance of up to 100 m or up to 300 m) and/or at a range between the close range and the distant range, in order to also ensure eye safety at greater distances to the LIDAR sensor.

In one advantageous embodiment of the present invention, the light energy in the central section of the beam distribution corresponds maximally up to 50%, preferably up to 20% and, in particular, preferably up to 10% of the light energy, which is present in each case in the sections including the peaks.

A width of the sections including the peaks further preferably corresponds to 2% to 30% and preferably 5% to 25% of a total width of the laser beam along the deflection direction of the LIDAR sensor.

The laser beam exiting the LIDAR sensor is preferably a collimated laser beam and a local spacing between the two peaks at the light exit interface is at least 1 cm, preferably at least 1.5 cm and, in particular, preferably at least 2 cm.

In one particularly advantageous embodiment of the present invention, the LIDAR sensor is configured to generate the double peak distribution with the aid of a plurality of optically coupled semiconductor lasers (also multi-junction lasers). Such a plurality of optically coupled semiconductor lasers includes, for example, a number from 4 to 10 semiconductor lasers or a number differing therefrom, which is situated in the form of a stack. A beam distribution to be generated with the aid of the plurality of coupled semiconductor lasers may also be varied by suitably establishing the distances of respectively adjacent semiconductor lasers and may thus be optimally adapted to respective eye safety requirements. Alternatively or in addition to the use of a plurality of optically coupled semiconductor lasers, it is possible to generate the beam distribution according to the present invention on the basis of an optical system that includes, for example, one or multiple beam-shaping elements (for example, lenses, etc.) in the optical path of the LIDAR sensor. The optical system is accordingly advantageously usable in combination with the plurality of optically coupled semiconductor lasers in order, for example, to further improve the beam distribution with respect to eye safety. On the other hand, it is possible on the basis of the optical system to produce the beam distribution according to the present invention solely on the basis of such an optical system, in which an optically non-coupled semiconductor laser stack is combined, for example, with a suitable beam-shaping optical system, so that it is possible, for example, to convert a Gaussian distribution of laser beams of such a stack into a double peak distribution according to the present invention.

In one advantageous embodiment of the present invention, the optical system includes a cube-shaped optical element, which is situated within the optical path of the LIDAR sensor in such a way that two opposing edges with respect to a focal point of the cube are situated within the optical path. An alignment of the two edges within the optical path advantageously corresponds to an arrangement direction of the plurality of semiconductor laser stacks of the transmitting unit.

The transmitting unit is preferably configured to emit laser light at a wavelength in the near-infrared range. It is noted that the LIDAR sensor according to the present invention is furthermore also able to generate laser light in a wavelength range differing therefrom.

The LIDAR sensor according to the present invention is further preferably a point scanner and, in particular, a line scanner.

### BRIEF DESCRIPTION OF THE DRAWINGS

Exemplary embodiments of the present invention are described in detail below with reference to the figures.

FIG. 1 schematically shows a top view of a LIDAR sensor according to the present invention in a first specific embodiment of the present invention.

FIG. 2 shows an example of a local beam distribution of a laser beam of a LIDAR sensor according to an example embodiment of the present invention.

FIG. 3a schematically shows a representation of a local distribution of a laser beam of the LIDAR sensor according to an example embodiment of the present invention.

FIG. 3b shows a temporal profile of the laser beam corresponding to FIG. 3a as it is viewed by an observer.

FIG. 4 schematically shows a representation of an optically coupled semiconductor laser stack.

FIG. 5 schematically shows a top view of a LIDAR sensor according to the present invention in a second specific embodiment of the present invention.

### DETAILED DESCRIPTION OF EXAMPLE EMBODIMENTS

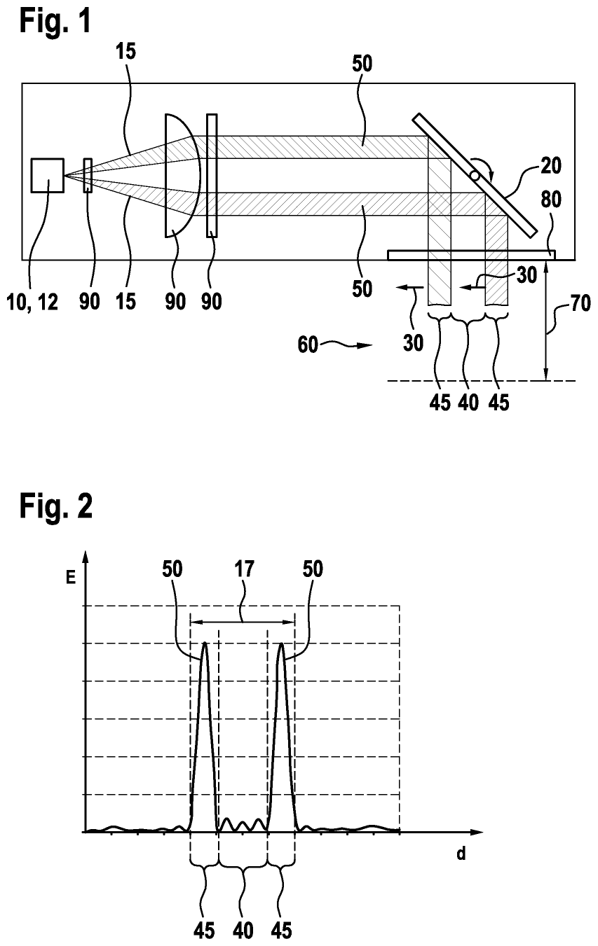

FIG. 1 schematically shows a top view of a LIDAR sensor according to the present invention in a first specific embodiment. The LIDAR sensor, which is designed here as a line scanner, includes a transmitting unit 10, which includes a plurality of stacks made up of five optically coupled laser diodes 12 each. Laser diodes 12 of the individual stacks are aligned here in each case transversely to the direction of resulting laser beam 15, whereas the respective stacks in the top view are situated one above the other. Laser diodes 12 in this case each emit light in the near-infrared wavelength range.

Optically coupled laser diodes 12 each generate a beam distribution, which corresponds to the above-described double peak distribution according to the present invention. A central section 40 of laser beams 15 of the respective stacks of laser diodes situated one above the other includes proportional light energy, which corresponds to maximally 10% of the light energy in respective edge sections 45 of laser beams 15. A width of edge sections 45, which include peaks 50 of the double peak distribution, corresponds here to approximately 25% of a total width of respective laser beams 15, whereas 95% of the light energy of laser beams 15 is situated here within a beam angle in the deflection direction of the LIDAR sensor of approximately 40°. The LIDAR sensor further includes a deflection unit 20, which is configured to deflect laser beams 15 generated by transmitting unit 10 and shaped by an optical system 90 along a deflection direction 30 into surroundings 60 of the LIDAR sensor.

On the basis of the preceding configuration, the LIDAR sensor is configured to ensure eye safety for an observer of laser beam 15 in a close range 70, which is defined here by a distance of up to 1 m with respect to a light exit window 80 of the LIDAR sensor.

FIG. 2 shows an example of a local beam distribution of a laser beam 15 of a LIDAR sensor according to the present invention. The beam distribution represents a local distribution of light energy E of the laser beam over distance d. A width 17 of laser beam 15 is also defined here, within which preferably 95% of the light energy of laser beam 15 is located.

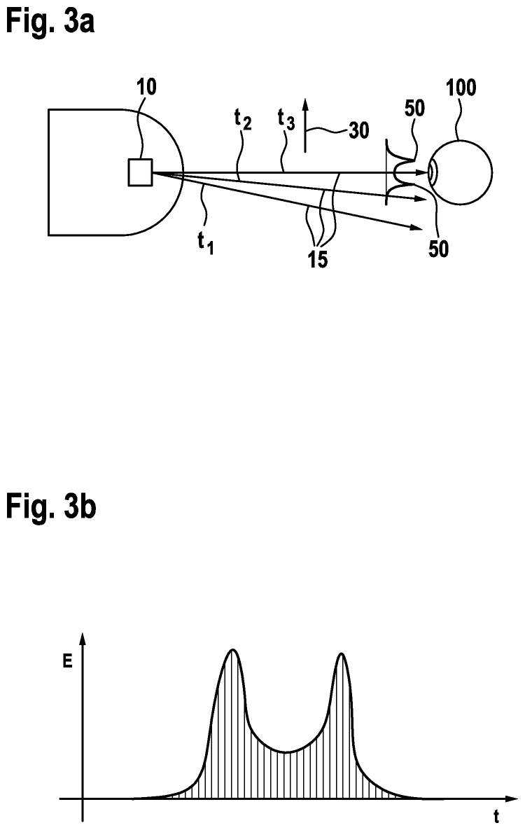

FIG. 3a schematically shows a representation of a local distribution of a laser beam 15 of the LIDAR sensor according to the present invention at different points in time t1, t2, and t3, which is generated by a transmitting unit 10. Laser beam 15, which includes the local distribution according to the present invention shown close to eye 100, is deflected by a deflection unit 20 (not shown) of the LIDAR sensor in deflection direction 30. As a result, peaks 50 of laser beam 15 strike the retina of eye 100 at different points in time, as a result of which eye safety of the LIDAR sensor is correspondingly enhanced with such a distribution.

FIG. 3b shows a temporal profile of the laser beam corresponding to FIG. 3a as it is viewed by an observer. The temporally offset striking of peaks 50 in eye 100 of the observer described in FIG. 3a, in particular, may be seen in FIG. 3b.

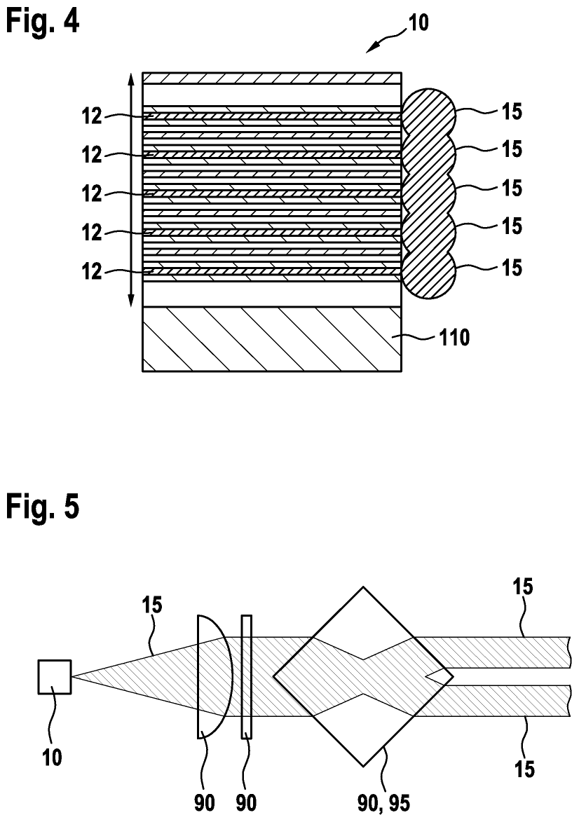

FIG. 4 schematically shows a representation of an optically coupled semiconductor laser stack of a transmitting unit 10 of the LIDAR sensor according to the present invention, the semiconductor laser stack here including by way of example five laser diodes 12, which are situated one above the other on a substrate 110. A local distribution resulting from the optical coupling of laser beams 15 of this stack corresponds to the above-described double peak distribution.

FIG. 5 schematically shows a top view of a LIDAR sensor according to the present invention in a second specific embodiment. The LIDAR sensor in the second specific embodiment includes a transmitting unit 10, which includes a plurality of stacks of optically non-coupled laser diodes 12, here each stack including an arrangement of three laser diodes 12 each. Laser beams 12 generated by this transmitting unit 10 each include a local distribution that corresponds to a Gaussian shape. The LIDAR sensor in the second specific embodiment also includes an optical system 90, which influences laser beams 15 of transmitting unit 10 in a suitable manner. As a result of cube-shaped optical element 95 in the optical path of the LIDAR sensor, a double peak distribution according to the present invention is generated, which ensures the eye safety of this LIDAR sensor in the close range of the LIDAR sensor. To avoid repetitions, a deflection unit 20 of the LIDAR sensor is not represented here.

What is claimed is:

1. A LIDAR sensor, comprising:
a transmitting unit; and
a deflection unit;
wherein the transmitting unit is configured to generate a laser beam whose local beam distribution along a deflection direction of the deflection unit includes a double peak distribution including two peaks, light energy of which in a central section between the two peaks is less by a predefined factor than light energy in sections in each case laterally adjacent to the central section which include the peaks, and
wherein the deflection unit is configured to deflect the laser beam generated by the transmitting unit along the deflection direction into surroundings of the LIDAR sensor.

2. The LIDAR sensor as recited in claim 1, wherein a height of the peaks of the double peak distribution and/or a width of the peaks of the double peak distribution and/or a spacing of the peaks of the double peak distribution are established in accordance with predefined eye safety requirements of the LIDAR sensor.

3. The LIDAR sensor as recited in claim 2, wherein the LIDAR sensor is configured to ensure the eye safety requirements in a close range of a light exit interface of the LIDAR sensor, the close range corresponding to a distance of up to 10 m from the light exit interface of the LIDAR sensor.

4. The LIDAR sensor as recited in claim 3, wherein the close range corresponds to a distance of up to 5 m.

5. The LIDAR sensor as recited in claim 4, wherein the close range corresponds to a distance of up to 1 m.

6. The LIDAR sensor as recited in claim 1, wherein the light energy in the central section of the beam distribution corresponds maximally up to 50% which is present in each case in sections including the peaks.

7. The LIDAR sensor as recited in claim 1, wherein the light energy in the central section of the beam distribution corresponds maximally up to 20% which is present in each case in sections including the peaks.

8. The LIDAR sensor as recited in claim 1, wherein the light energy in the central section of the beam distribution corresponds maximally up to 10% which is present in each case in sections including the peaks.

9. The LIDAR sensor as recited in claim 1, wherein a width of sections including the peaks corresponds to 2% to 30% of a total width of the laser beam along the deflection direction.

10. The LIDAR sensor as recited in claim 1, wherein a width of sections including the peaks corresponds to 5% to 25% of a total width of the laser beam along the deflection direction.

11. The LIDAR sensor as recited in claim 1, wherein the laser beam exiting the LIDAR sensor is a collimated laser beam and a local spacing between the two peaks at a light exit interface is at least 1 cm.

12. The LIDAR sensor as recited in claim 1, wherein the laser beam exiting the LIDAR sensor is a collimated laser beam and a local spacing between the two peaks at a light exit interface is at least 1.5 cm.

13. The LIDAR sensor as recited in claim 1, wherein the laser beam exiting the LIDAR sensor is a collimated laser beam and a local spacing between the two peaks at a light exit interface is at least 2.0 cm.

14. The LIDAR sensor as recited in claim 1, wherein the LIDAR sensor is configured to generate the double peak distribution using:
a plurality of optically coupled semiconductor lasers; and/or
an optical system in an optical path of the LIDAR sensor.

15. The LIDAR sensor as recited in claim 12, wherein the optical system includes a cube-shaped optical element, which is situated within the optical path of the LIDAR sensor in such a way that two opposing edges with respect to a focal point of the cube are situated within the optical path.

16. The LIDAR sensor as recited in claim 1, wherein the transmitting unit is configured to emit laser light at a wavelength in a near-infrared range.

17. The LIDAR sensor as recited in claim 1, wherein the LIDAR sensor is a point scanner or a line scanner.
